(19) United States
(12) Patent Application Publication
(10) Pub. No.: US 2026/0297394 A1
(43) Pub. Date: Oct. 1, 2026

(54) Adhesive Patch System for Smoking Product

(71) Applicant: Faatima Bussey, Paulsboro, NJ (US)

(72) Inventor: Faatima Bussey, Paulsboro, NJ (US)

(21) Appl. No.: 19/634,144

(22) Filed: Mar. 31, 2026

Related U.S. Application Data
(60) Provisional application No. 63/780,862, filed on Mar. 31, 2025.

(51) Int. Cl. C09J 7/38; A24C 1/00; A24F 47/00; C09J 5/00; C09J 7/21; C09J 7/40; C09J 11/06

(52) U.S. Cl. CPC C09J 7/38; A24C 1/00; A24F 47/00; C09J 5/00; C09J 7/21; C09J 7/405; C09J 11/06; C09J 2400/28

(57) ABSTRACT

A system and method for repairing a wrapper of a smoking product are disclosed. The system includes a smokable patch sized to cover a tear, hole, or separation in a wrapper, wherein the smokable patch comprises a tobacco patch or a non-tobacco patch. An edible adhesive that is safe to eat and smokable is disposed on at least a portion of the smokable patch, and a removable release liner covers the edible adhesive prior to application. Removal of the release liner exposes the edible adhesive and permits the smokable patch to be applied to the wrapper to restore structural integrity without moistening the smokable patch or the wrapper during application. In some embodiments, one or more smokable patches are stored in a container configured to reduce air exposure, wherein the container may be resealable to limit oxygen exposure and preserve adhesive effectiveness prior to use.

### FIELD OF THE INVENTION

The present invention relates to the field of smoking products. Specifically, the present invention relates to a wrapper repair patch for the wrapper of smoking products.

### BACKGROUND OF THE INVENTION

This disclosure relates generally to systems and methods for repairing wrappers of smoking products. As used herein, “smoking products” include smokeable material wrapped in a wrapper, including cigars, cigarillos, cigarettes, and roll-your-own products. This disclosure further relates to packaging configured to store one or more repair patches and preserve adhesive effectiveness prior to use. Wrappers of smoking products may tear, crack, or separate during handling, storage, or rolling, compromising structural integrity and usability and motivating improved wrapper repair systems and storage approaches.

U.S. Pub. No. 2003/0136705 A1 filed Jan. 23, 2002, by Robert Roth describes a cigar repair kit that stores wrapper-leaf patches (e.g., in bags) within a box having a cedar insert and, in some embodiments, a humidification feature, and further describes a moisture-assisted repair method in which a patch is wetted during application. Such approaches emphasize humidification-based storage and wet-application techniques, rather than a peel-and-apply system having a removable release liner and packaging configured to preserve adhesive effectiveness by limiting oxygen exposure.

U.S. Pub. No. 2013/0014770 A1 filed Jan. 17, 2013, by Demarcos Luna describes a system and method for patching and accessorizing a cigarette or cigar. Luna discloses rolling-paper patches in some embodiments, are provided on larger printable sheets with perforations for separating individual patches. Such sheet-based patch formats can be susceptible to drying or loss of usability when stored improperly over time, and the disclosure does not emphasize packaging configured to preserve adhesive effectiveness for rapid wrapper repair.

### SUMMARY OF THE INVENTION

The present invention relates to systems for repairing wrappers of smoking products. In one aspect, a system for repairing a wrapper of a smoking product includes a smokable patch sized to cover a tear, hole, or separation in the wrapper, wherein the smokable patch comprises a tobacco patch or a non-tobacco patch. An edible adhesive that is safe to eat and smokable is disposed on at least a portion of the smokable patch and is configured to adhere the smokable patch to the wrapper. A removable release liner covers the edible adhesive prior to application such that, upon removal of the release liner, the smokable patch may be applied to the wrapper to restore structural integrity of the smoking product without moistening the smokable patch during application.

In another aspect, a method of repairing a wrapper includes removing the release liner and applying the smokable patch to a damaged portion of the wrapper to adhere the smokable patch to the wrapper.

In one or more embodiments, the system includes a container configured to store one or more smokable patches and reduce air exposure prior to use, wherein the container may be resealable and configured to limit oxygen exposure to preserve adhesive effectiveness.

### BRIEF DESCRIPTION OF THE DRAWINGS

FIGS. 1, 2, and 3 illustrate a patch with a removable release liner and an example method of removing the release liner.

FIG. 4 illustrates the patch applied to a wrapper of a smoking product.

FIG. 5 illustrates an embodiment in which one or more patches are stored in a sealed pouch.

FIG. 6 illustrates an embodiment of the sealed pouch including a label region or printed indicia.

FIGS. 7-10 illustrate an embodiment of a container configured to store one or more patches, including a lid or cover.

FIGS. 11-13 illustrate an embodiment of a container configured to store one or more patches, including a closure member.

FIG. 14 illustrates an embodiment of the container.

The present invention is illustrated by way of example and not limited to the figures of the accompanying drawings in which references indicate similar elements.

### DETAILED DESCRIPTION OF THE INVENTION

For purposes of illustration and not limitation, the reference numerals used in the drawings include: smokable patch (100), edible adhesive (101), removable release liner (102), smoking product (103), sealed pouch (104), label region or printed indicia (105), container (106), lid or cover (107), and hinge or closure member (108).

In some embodiments, the smokable patch comprises a tobacco patch or a non-tobacco patch configured to be smoked when used to repair a wrapper.

In one or more embodiments, one or more smokable patches are stored in a container configured to reduce air exposure, wherein the container may be resealable to limit oxygen exposure and preserve adhesive effectiveness.

In some embodiments, the container is configured to limit oxygen exposure without requiring a humidification medium.

In some embodiments, the system includes a disposable container configured to limit air exposure when closed.

Various embodiments and aspects of the invention may be described with reference to the details discussed above.

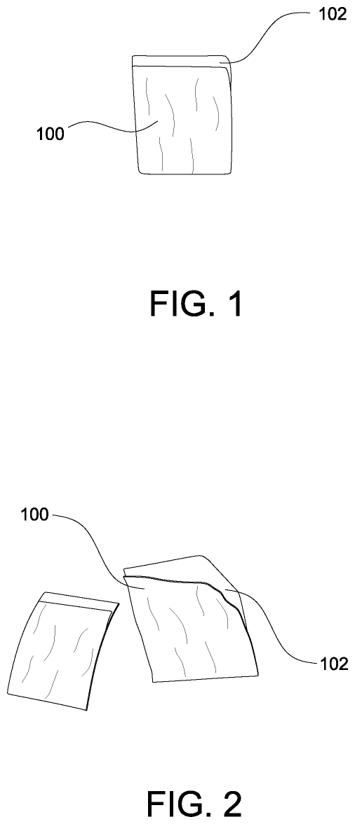

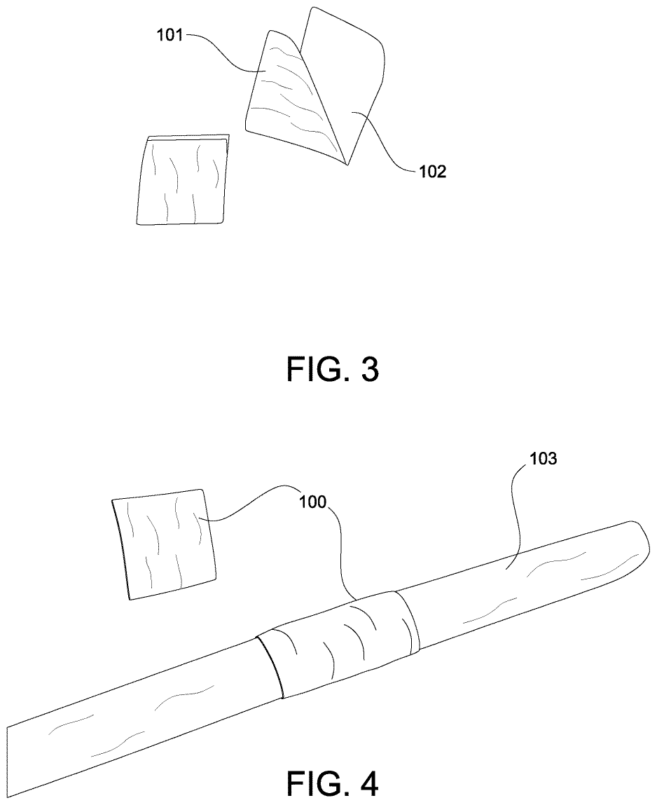

FIGS. 1-3 illustrates how one embodiment of the present invention would be used. A user can pick up a patch 100 and remove the release liner 102. In one or more embodiments, the patch 100 is smokable and may comprise a tobacco patch or a non-tobacco patch and could be manufactured from wood pulp, hemp, flax, rice, esparto, or tobacco. The patch 100 may have a length in the range of 7 to 50 mm and a width in the range of 7 to 50 mm. The patch is covered in an adhesive 101 on one side. In one embodiment, the adhesive side of the patch is covered by a release liner 102 with a length in the range of 8 to 60 mm and a width in the range of 7 to 50 mm. The liner 102 is longer than the patch 100 to ensure that users can easily peel off the liner from the patch. In one embodiment, the release liner 102 could be made of silicone release liner, parchment paper, fluorosilicone paper, wax paper, clear film tape, glassine, super calendared kraft, machine glazed kraft paper, clay coated kraft paper, polyethylene coated kraft paper, polyethylene terephthalate plastic film, polypropylene plastic film, or polyethylene film.

In some embodiments, the removable release liner has dimensions from about 8 to 60 millimeters in length, about 7 to 50 millimeters in width, and about 0.01 to 0.2 millimeters in thickness.

FIG. 4 illustrates one embodiment of patch 100 as it would appear after being applied to the damaged section of a cigar 103.

In one embodiment the adhesive is an edible adhesive that is safe to eat and smokable. The edible adhesive comprises tapioca, acacia powder, glutinous rice, molasses, glycerin, and sodium benzoate. To produce at least 60 g of adhesive the amount of 5 to 15 ml of tapioca starch, 2.5 to 7.5 ml of acacia powder, 2.5 to 7.5 ml of glutinous rice, 0.5 to 2.5 ml of molasses, 1.5 to 3.5 tsp of sodium benzoate are mixed into 60 ml of water. The mixture is boiled and stirred for 5-8 minutes. The mixture is poured into a sealable container. 3.5 to 6.5 ml of glycerin is then added to the mixture and stirred until the texture loosens to a consistency that can be easily spread onto a patch. Mixture in container is sealed and then allowed to cool to room temperature. After cooling the mixture is ready to be applied to a patch.

In some embodiments, a method of producing the edible adhesive includes mixing tapioca, acacia powder, glutinous rice, molasses, sodium benzoate, and water; heating the mixture while stirring; adding glycerin; continuing to stir until lumps dissolve to form a smooth texture; sealing the mixture in a container; and allowing the mixture to cool.

In some embodiments, the edible adhesive comprises a mixture including about 17% to 25% by volume of tapioca, about 3% to 6% by volume of acacia powder, about 3% to 6% by volume of glutinous rice, about 0.5% to 2% by volume of molasses, about 4% to 6% by volume of glycerin, about 2% to 6% by volume of sodium benzoate, and about 51% to 70% by volume of water.

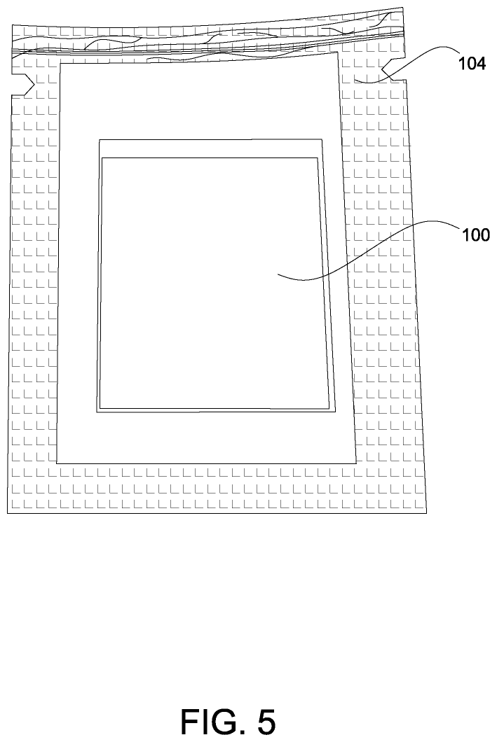

In one embodiment, the width of the bag 104 as illustrated in FIG. 5 would be in the range of 3 to 5 cm and the height would be in the range of 4 to 6 cm.

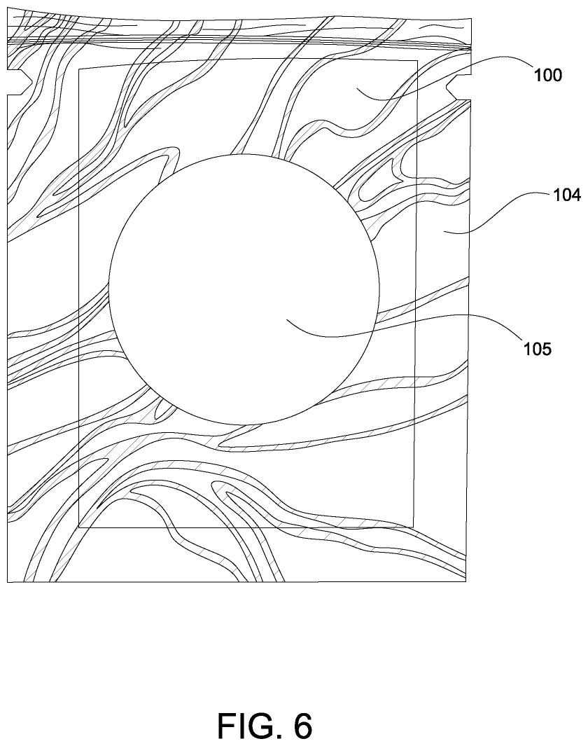

In one embodiment, the bag 104 as illustrated in FIG. 6 provides space for a label region or printed indicia 105 to be printed on the center of the bag. In this embodiment, the bag 104 could hold up to twenty adhesive coated patches and prevents the patches from drying out by limiting air exposure.

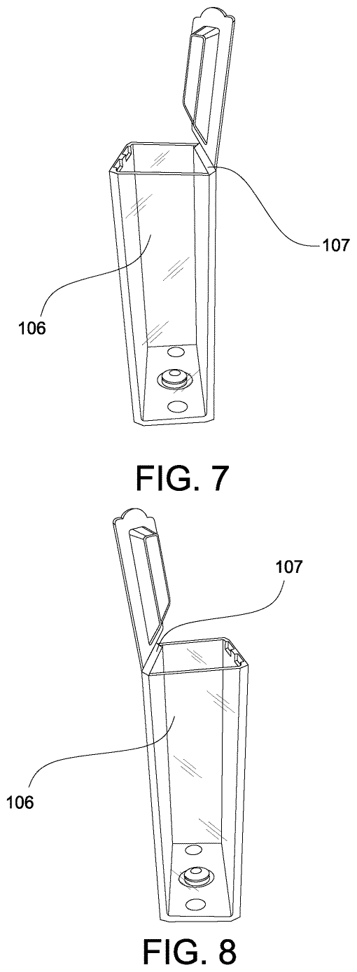

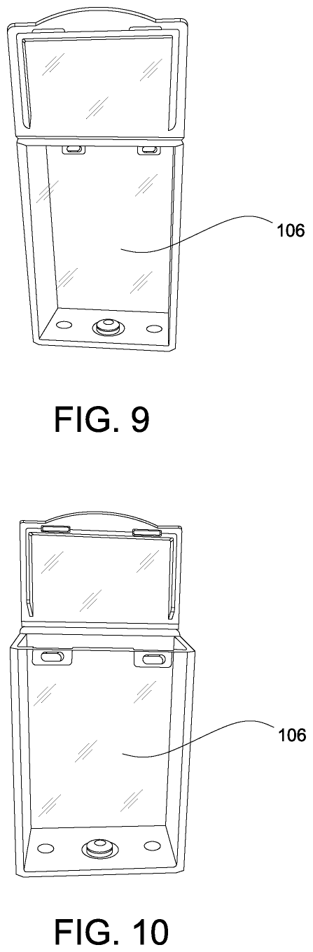

FIGS. 7-10 illustrates one embodiment where the present invention is packaged in a cartridge 106. In this embodiment, the cartridge could be made of plastic. In this embodiment, the lid of the cartridge 106 is attached by a thin plastic living hinge 107 which allows the cartridge 106 to be manufactured as a single product as opposed to two separate components.

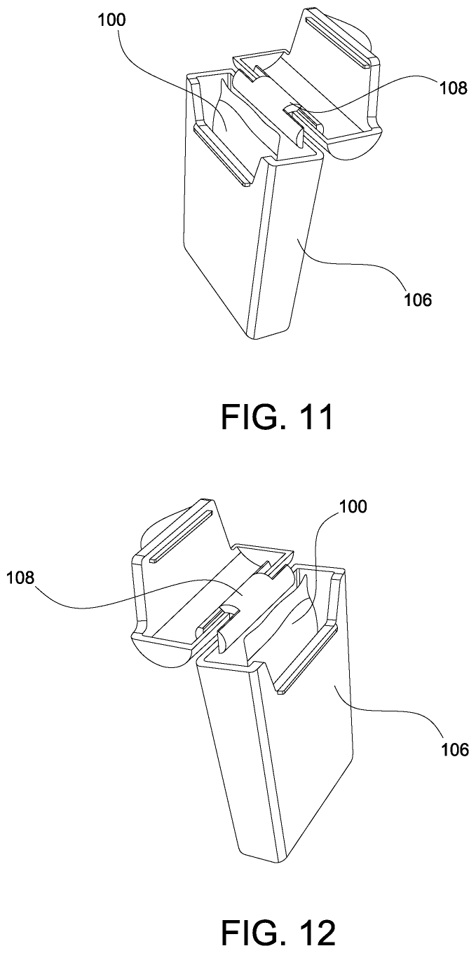

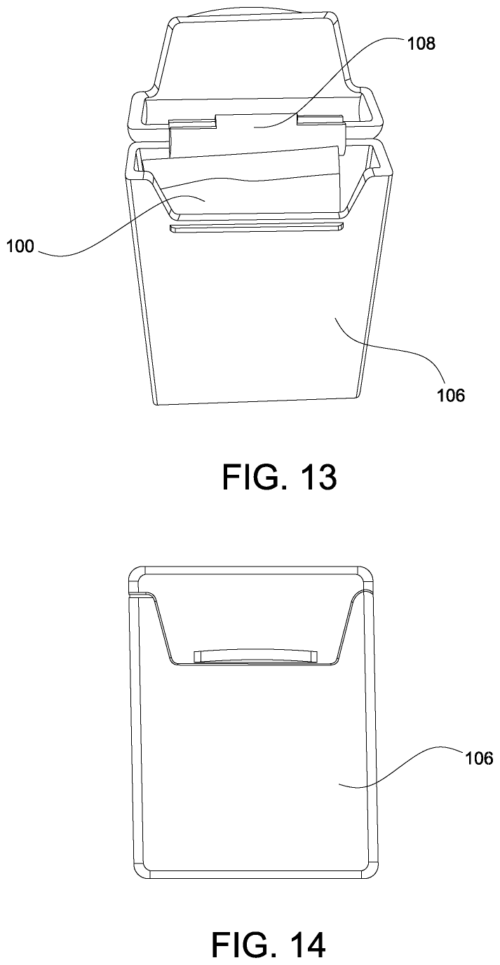

FIGS. 11-13 illustrates how a patch 100 fits within a cartridge 106. In one embodiment, the lid of the cartridge 106 is attached by a traditional hinge 108. In both embodiments, the cartridge 106 can have a width in the range of 17 to 33 mm, a height in the range of 25 to 40 mm, and a thickness in the range of 5 to 10 mm.

FIG. 14 illustrates the cartridge 106 in a closed configuration with a tab that allows a user to easily open the cartridge to retrieve an adhesive coated patch. The closed cartridge limits air exposure to the patch to maintain freshness.

It is to be understood that the drawings are designed for the purpose of illustration only and are not intended for use as a definition of the limits and scope of the invention disclosed.

1. A system for repairing a wrapper of a smoking product, comprising:
(a) a smokable patch sized to cover a tear, hole, or separation in the wrapper of the smoking product, wherein the smokable patch comprises a tobacco patch or a non-tobacco patch; (b) an edible adhesive disposed on at least a portion of the smokable patch, the edible adhesive being configured to adhere the smokable patch to the wrapper, wherein the edible adhesive is safe to eat and smokable; and(c) a removable release liner covering the edible adhesive prior to application, wherein removal of the release liner exposes the edible adhesive and permits the smokable patch to be applied to the wrapper to restore structural integrity of the smoking product, and wherein the smokable patch is configured to be applied to the wrapper without moistening the smokable patch or the wrapper during application.

2. The system of claim 1, wherein the smoking product comprises a cigar, cigarillo, blunt, cigarette, or roll-your-own smoking product.

3. The system of claim 1, wherein the smokable patch comprises a tobacco patch or a non-tobacco patch.

4. The system of claim 1, wherein the smokable patch comprises a material selected from the group consisting of wood pulp, hemp, flax, rice, esparto, tobacco, rolling paper, tobacco leaf, hemp paper, rice paper, and cellulose-based paper.

5. The system of claim 1, wherein the edible adhesive comprises gum arabic, pectin, xanthan gum, starch, tapioca, or a sugar-based adhesive.

6. The system of claim 1, wherein the edible adhesive comprises tapioca, acacia powder, glutinous rice, molasses, glycerin, sodium benzoate, and water.

7. The system of claim 6, wherein the edible adhesive comprises a mixture including 17% to 25% by volume of tapioca, 3% to 6% by volume of acacia powder, 3% to 6% by volume of glutinous rice, 0.5% to 2% by volume of molasses, 4% to 6% by volume of glycerin, 2% to 6% by volume of sodium benzoate, and 51% to 70% by volume of water.

8. A method of producing the edible adhesive of claim 6, comprising: mixing tapioca, acacia powder, glutinous rice, molasses, sodium benzoate, and water; heating the mixture while stirring; adding glycerin; continuing to stir until lumps dissolve to form a smooth texture; sealing the mixture in a container; and allowing the mixture to cool.

9. The system of claim 1, further comprising a container configured to enclose the smokable patch and reduce air exposure to preserve adhesive freshness prior to use, wherein the container may be resealable to limit oxygen exposure and preserve adhesive effectiveness.

10. The system of claim 9, wherein the container comprises a resealable pouch, cartridge, or blister package.

11. The system of claim 9, wherein the container is configured to limit oxygen exposure without requiring a humidification medium.

12. A method of repairing a wrapper of a smoking product using the system of claim 1, comprising: removing the release liner from the smokable patch and applying the smokable patch to a damaged portion of the wrapper to adhere the smokable patch to the wrapper and restore structural integrity.

13. The system of claim 1, wherein the release liner comprises a material selected from the group consisting of silicone release paper, parchment paper, fluorosilicone paper, wax paper, clear film tape, glassine, super calendared kraft, machine glazed kraft paper, clay coated kraft paper, polyethylene coated kraft paper, polyethylene terephthalate plastic film, polypropylene plastic film, and polyethylene film.

14. The system of claim 13, wherein dimensions of the removable release liner are from 8 to 60 millimeters in length, 7 to 50 millimeters in width, and 0.01 to 0.2 millimeters in thickness.

15. The system of claim 1, wherein dimensions of the smokable patch are from 7 to 50 millimeters in length, 7 to 50 millimeters in width, and 0.01 to 0.2 millimeters in thickness.

16. The system of claim 1, further comprising a disposable container.

17. The system of claim 16, wherein the disposable container limits air exposure when closed.
